(19) United States
(12) Patent Application Publication
(10) Pub. No.: US 2008/0010135 A1
(43) Pub. Date: Jan. 10, 2008

(54) DIGITAL MEDIA CONTENT DEVICE INCENTIVE AND PROVISIONING METHOD

(75) Inventor: Jeff Schrock, Seattle, WA (US)

Correspondence Address: AXIOS LAW GROUP, PLLC / REALNETWORKS, INC, 1525 FOURTH AVENUE, SUITE 800, SEATTLE, WA, 98101, US

(73) Assignee: REALNETWORKS, INC., Seattle, WA (US)

(21) Appl. No.: 11/456,358

(22) Filed: Jul. 10, 2006

(51) Int. Cl. G06Q 30/00

(52) U.S. Cl. 705/14

(57) ABSTRACT

A method of providing an incentive for purchasing a digital media content playing electronic device is provided herein.

### FIELD

The present invention generally relates to digital media and, more particularly, incentives to purchase digital media content devices.

### BACKGROUND

Communications between electronic devices have improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

The use of global distribution systems such as the Internet for distribution of digital media content such as music, video, computer programs, pictures, games and other content continues to grow. Accordingly, owners and publishers of valuable digital media content have seen a dramatic increase in their revenues from the use of the Internet for distribution of digital assets.

In the past, the barriers to increasing the revenue from electronic distribution of digital media content have been primarily due to a lack of an acceptable media distribution system. However, a number of media distribution systems have been adopted by service providers that work with content providers (e.g., content creators, owners, wholesale distributors and producers). For example, the RHAPSODY® and RHAPSODY-TO-GO™ services offered by RealNetworks® of Seattle, Wash. provide content services to electronic devices (e.g., computers, MP3 players and the like). A content service provider system may distribute media content by allowing a user to download media data files and/or receive and process media data streams.

Conventional models for selling digital media content have a few actors in the digital media marketplace: Digital media device provider (e.g., device seller, device makers, and device components suppliers, and the like), digital media content providers (e.g., artists, developers, labels, studios, media companies, musicians, authors, publishers, wholesale distributors and the like), and digital media service providers (e.g., content streamers, content aggregators, content retailers, and the like) and of course digital media content consumers (e.g., consumers, consumer devices, and the like). One example of a digital media content marketplace involves the distribution of digitally encoded music data. Such a conventional implementation of digital media content might have musicians (content providers) creating music that has been recorded for distribution by a music label (another content provider). The music label would distribute wholesale digitally encoded music to various channels, possibly including an online music provision service (service provider) that hosts and delivers the digitally encoded music data for download and/or streaming to a consumer device. The consumer would then transfer any downloaded digital music to a digital media playing device if they so choose. For digitally encoded music, such devices are often MP3 (Motion Picture Experts Group-1 layer three audio) players. Consumers may pay for content provided by a service provider through a number of different mechanisms including paying for individual pieces of content and/or subscribing to a service that provides multiple pieces of digital media content (or a continuous stream of digital media content). Likewise, the service providers share their revenue with content providers (either creators or aggregators) via royalty payments or similar payment mechanisms to compensate the content provider for the digital medial content that the service provider provides to consumers.

One limiting factor of the current digital media content marketplace it is that there is a high cost to consumers to enter the marketplace. Digital media content devices are often sophisticated electronic devices using the latest (and often expensive) components. Therefore, consumers that might have been willing to spend a substantial amount of money over an extended period of time to obtain digital media content may not enter the marketplace (or do not buy a digital media content device to make full use of available digital media content) as the initial cost of a desirable device may be cost prohibitive to the consumer.

Such cost prohibitive devices have forced some companies to try to change the marketplace by eliminating one or more actors in the marketplace. This reduction in the number of actors comes from companies' need to reduce the cost of devices, yet still be able to recoup sufficient revenues from the sale of digital media content. One example of this practice is prevalent in the console game industry. Some console game providers combined the roles of service provider, device provider and/or content provider. For example, Microsoft® Corporation of Redmond, Wash. sells the Xbox® console game device, distributes Xbox® software game titles (both online and via retail establishments) and is the content provider for at least some of the software for the console games playable on the Xbox®. If Microsoft® were a game device seller that had to recoup the cost of manufacturing and selling the Xbox® game device, Microsoft® would have to sell the game device at a higher price point. However, as there is no separation between the device provider and service provider, Microsoft® is able to receive income from both the sale of the Xbox® device and the sale of content for the Xbox® device. Accordingly, Microsoft® subsidizes the price of the Xbox® device in the interest of increasing the number of Xbox® content purchasers and receiving content revenue over time.

In the digital media content marketplace, service providers have been known to provide incentives to purchase a digital media content device in exchange for consumers agreeing to utilize their services. For example, in exchange for signing up for an audible.com account, users may receive a discount on an Apple® iPod® digital medial device from Apple Computer, Inc., Cupertino, Calif. However, the incentive that a sole service provider may be able to offer to a consumer may not be cost effective for either the service provider or consumer given that the service provider's market position may not enable the service provider to offer a sufficient incentive to affect a consumer's device purchasing decision.

One additional concern regarding the distribution of digital goods is the need to provide “digital rights management” (“DRM”) protection to prevent unauthorized distribution, copying and/or illegal operation, or access to the digital goods. Digital rights management is fast becoming a central requirement if online commerce is to continue its rapid growth. Content providers and the computer industry must quickly address technologies and protocols for ensuring that digital goods are properly handled in accordance with the rights granted by the developer/publisher. If measures are not taken, traditional content providers may be put out of business by widespread theft or, more likely, will refuse altogether to deliver content online.

Various DRM techniques have been developed and employed in an attempt to thwart potential pirates from illegally copying or otherwise distributing the digital goods to others. For example, one DRM technique includes requiring the consumer to insert the original CD-ROM or DVD for verification prior to enabling the operation of a related copy of the digital good. Unfortunately, this DRM technique typically places an unwelcome burden on the honest consumer, especially those concerned with speed and productivity. Moreover, such techniques are impracticable for digital goods that are site licensed, such as software products that are licensed for use by several computers, and/or for digital goods that are downloaded directly to a computer. Additionally, it is not overly difficult for unscrupulous individuals/organizations to produce working pirated copies of the CD-ROM.

### BRIEF SUMMARY OF THE DRAWINGS

FIG. 1 illustrates an exemplary digital media content marketplace in accordance with various embodiments.

FIG. 2 is a flow diagram illustrating an exemplary process for obtaining a content provider incentive in accordance with various embodiments.

FIG. 3 is a pictorial diagram of a number of interconnected devices that provide a digital media content in accordance with various embodiments.

### DETAILED DESCRIPTION

Various embodiments are directed at providing consumers with meaningful incentive to purchase digital media content devices (and thereby increase the demand for digital media content) purchased by consumers.

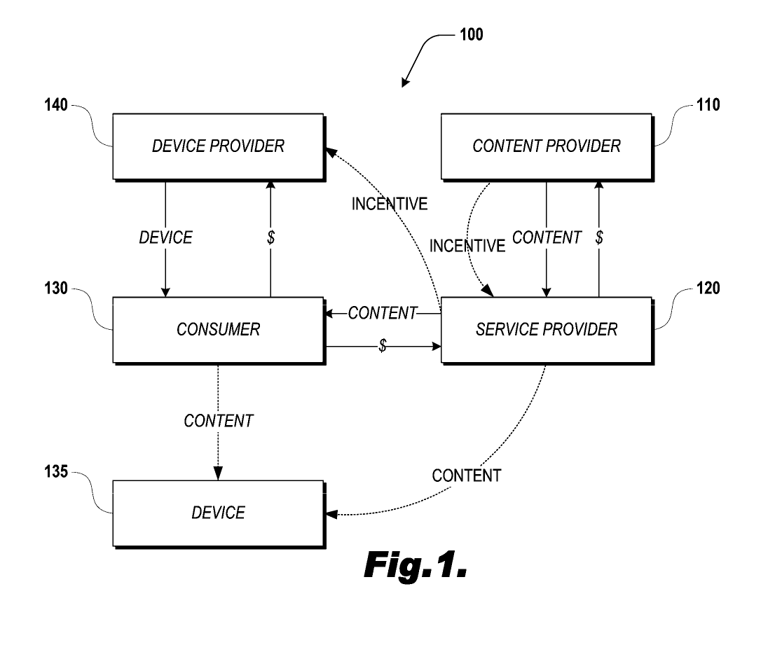

FIG. 1 illustrates an exemplary arrangement of the entities within a digital media content marketplace 100. Digital media content is introduced into the marketplace by content provider 110. In various embodiments, content providers may be studios, publishers, musicians, artists, authors, directors and the like. Content providers 110 are those people and/or companies who provide the service providers with online music, video, software, game, text and other media content providers and the like. In exchange for the content, the service providers either pay for the content outright or agree to pay a royalty based on the sale of digital media content provided by the content provider (e.g. on a per item basis, on a per play basis, on a percentage of revenue basis or the like). Service providers 120 then in turn interact with the consumer 130 to supply the consumer 130 with digital media content in exchange for revenues from the consumer 130. The consumer may load digital media content onto their digital media content device 135 and may share content usage information with the service provider 120.

Similarly, the consumer 130 interacts with a device provider 140 (device seller, device maker, and/or device component supplier) to obtain their digital media device 135. In a conventional example, a device maker (not shown) receives components from a device components supplier (not shown) and assembles the components into a device that has been provided to a device seller (not separately shown) for sale and delivery to a consumer 130.

In one exemplary embodiment, instead of combining one or more of the actors in the marketplace, a service provider may secure an agreement from a content provider 110 to obtain a digital media incentive that will enable a consumer 130 to purchase a device 135 at a reduced cost, thereby lowering barriers to entry for the consumer 130. The service provider 120 would in turn provide the digital media incentive to a device provider (including one or more of a device seller, device maker and/or device components supplier). By providing incentives (payments, coupons, instant rebates, mail-in rebates and the like), it enables device providers 140 to reduce their costs and pass on the cost savings to consumers 130.

So far, service providers 120 have remained aloof from the issues related to the high cost of digital media content devices. Under conventional “brick and mortar” retailing of conventional media, it would have been difficult to account for the participation of different content providers 110 in promoting media playing equipment. However, with the advances in digital media content devices, the desirable digital media content devices are those that contain sufficient content to satisfy user's desires. To the extent that the digital media content requires complex graphics and sound data, the digital media content electronic devices that are able to play such content are expensive. However, these digital media content devices are also desirable for consumers. Accordingly, if service providers wish to increase the overall market for the digital media content they provide, it is desirable to increase the number of digital media content devices used by consumers 130.

Described below are a number of exemplary embodiments of ways to provide new incentives to consumers to enable the purchase of digital media content devices at a reduced cost.

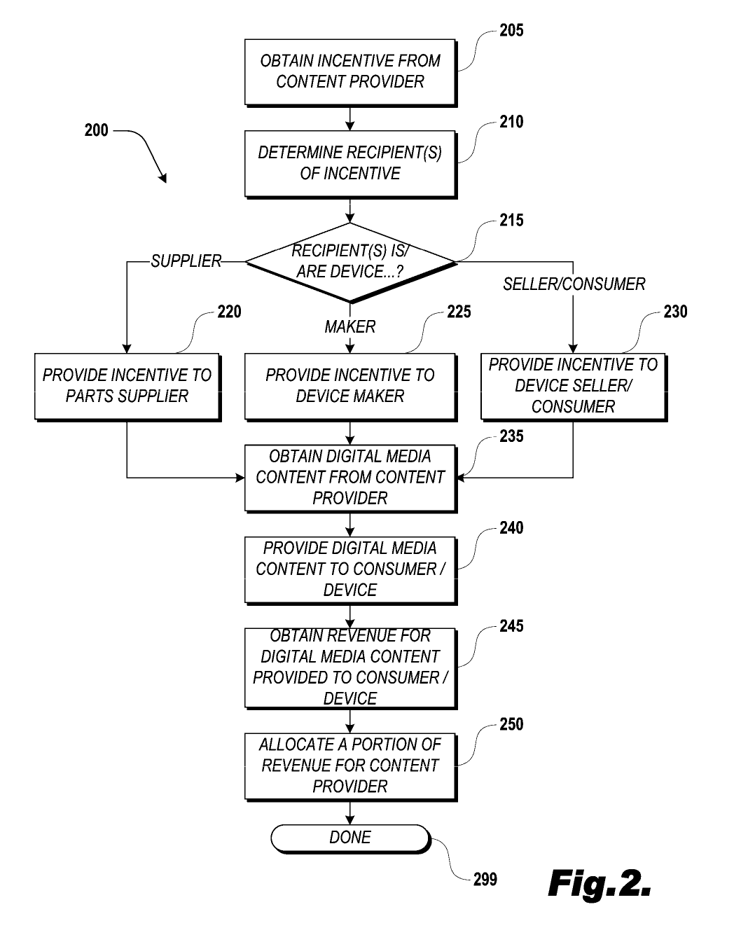

More specifically, FIG. 2 illustrates a flow diagram of a simplified method that implements a content provider incentive in the digital media content marketplace 100. In block 205, the service provider 120 obtains an incentive from the content provider 110. Next, in block 210 the service provider determines the recipient or recipients (e.g., device provider and/or consumer) of the incentive. In decision block 215 a determination is made whether the recipient or recipients are a device supplier, a device maker, a device seller and/or a device consumer 130 and accordingly all or a part of the incentive is sent to each of the determined recipients in blocks 220, 225 and 230. Next, in block 235, digital media content is obtained from the content provider 110 and provided to the consumer 130 and consumer device 135 in block 240. Revenue for the provided digital media content is obtained in block 235. In block 250, a portion of the obtained revenue is allocated for the content provider. The process ends in block 299.

In an example of the simplified process of FIG. 2, a content provider 110 agrees to a reduced royalty rate for content provided to the service provider 120. The service provider 120 is then able to afford to pass on an incentive to a device provider 140 to enable a consumer 130 to purchase a digital media content device 135 at a reduced price. The service provider is able to afford the cost of the incentive because the content provider has agreed to a reduced royalty rate; thereby reducing the service provider's other costs.

For example, in the content marketplace 100, a consumer 130 may want to purchase an electronic device 135 that costs $400 from a device provider 140. However, an acceptable price that would convince the consumer 130 to buy the electronic device is $300. Accordingly, if the content provider 110 and the service provider 120 both subsidize the cost of the electronic device 135 by $50, the cost to the consumer 130 would be acceptable, and would thereby cause the consumer 130 to join the content marketplace 100.

In some embodiments, where the service provider 120 advances the content provider's share of an incentive, the service provider 120 would wish to recoup the cost of the incentive. Accordingly, in some embodiments, the service provider 120 would temporarily reduce the amount of its royalties to the content provider 110. In embodiments where a royalty payment is paid by a service provider 120 to a content provider 110, the royalty payment may be adjusted once a service provider recoups it expenses related to the incentive. When a service provider 120 begins paying royalties at a non-reduced rate could be determined in a variety of fashions, however in some embodiments a time period may be used (e.g., reduced royalties for a year). Other factors used to determine a reduced royalty period may include, but are not limited to: when revenues attributable to the reduced royalties reaches a predetermined amount, when a number of digital media content purchases is reached, a number of digital media content usages is reach, combination of the foregoing, and the like.

In one specific example marketplace 100, presume that each piece of digital media content incurs a royalty to a subscription-based service provider 120 of $0.04 to play a streamed or downloaded track once. Also, assume that an average consumer 130 plays (downloads or streams) two hundred songs in a given subscription period (with a subscription cost of $15). There would be $8 in royalties due to the content provider(s) 110 at the end of a subscription period. If content provider(s) 110 were willing to reduce the required royalty payment by half (i.e., to $4), then the service provider 120 would be able to recoup the advanced incentive in twelve and a half subscription periods ($4×2.5=$50).

In an alternate implementation, assume that a device 135 costs $400 from a device provider 140. A content provider 110 and a service provider 120 each subsidize the device 135 at $50 apiece. Assume also that a consumer 130 purchases digital media content from the service provider at $0.89 per item of digital media content. If each of the service provider 120 and content provider 110 ordinarily receive $0.20 per item of digital media content, assume that the content provider's share (royalty) is halved to recoup the effects of an advanced digital media incentive. A consumer 130 would have to purchase five hundred songs in order for the service provider 120 to recoup the advanced incentive. This amounts to about forty-five albums of digital music files (given eleven songs on an ordinary album).

These two models are not meant to be exclusive; they may be combined such that streamed and purchased digital media content may be used to account for royalties owed to a content provider 110, as well as revenue used to recoup expenses of a service provider 120. Likewise, sliding scales may be used that vary over periods of time, such that it is not a “shock” due to significant price changes to either a service provider 120 or a content provider 110.

It should be noted that in some implementations it might not be as cost effective to subsidize an electronic device 135 at a retail level. If a device component provider (not separately shown) received the incentive, it might reduce the need for as large an incentive from the service provider 120 and content provider 110. In one example, a device component provider might receive a $37.50 incentive from each of a service provider 120 and a content provider 110, for a total incentive of $75. If the component cost for the electronic device's components were $250 without the incentive, the subsidized price would be $175. Accordingly, assuming a markup of thirty percent at a device manufacturer (not separately shown) and thirty percent at a device retailer (not separately shown) a subsidized device would cost $295.75 and an unsubsidized device would cost $422.50. At a $37.50 incentive and a content provider giving a royalty forgiveness of $0.15, a consumer 130 would have to purchase two hundred and fifty songs (about twenty-three albums) in order for the service provider 120 to recoup an advanced content provider incentive.

In further embodiments, a content provider 110 may provider the incentive directly to a device provider 140. Similar calculations to those listed above may be used by a content provider to determine an acceptable incentive/subsidy for reducing the purchase price of a digital media content device 135.

The numbers used for device costs, royalties, content costs and the like listed above are merely provided as examples and are not meant to limit the scope of the envisioned embodiments. For example, alternate incentives may not use an incentive when dealing with a device provider, rather a coupon or other incentive may be provided to the consumer. Coupons have the benefit that they may be used with multiple device providers.

For simplicity's sake, the above descriptions include a single content provider. In some embodiments, more than one content provider 110 may provide an incentive. Accordingly, the service provider 120 would aggregate the incentives to increase the incentive offered to a consumer 130 or device provider 140 to enable a digital media content device 135 to be purchased at a reduced price. The revenue allocations for multiple service providers may in turn be determined in a number of different fashions. In one embodiment, the total revenues attributed specific content from a content provider to determine how revenues should be allocated to that content provider. Accounting for each piece of digital media content may be inefficient. Therefore, in alternate embodiments, a content provider's market share or revenue (e.g., with the service provider 120) may be used to determine how to allocate revenues received for digital media content at the service provider 120. In yet other embodiments, the usage (e.g., playing, executing, depicting, broadcasting and the like) of digital media content may be employed when determining how revenues are allocated to one or more content providers.

Furthermore, in some embodiments, there may be different types of digital media incentives. In some cases, specific digital media content may have related incentives (e.g., certain artists may specify a reduced royalty rate to provide an incentive). Accordingly, the digital media incentive might be divided between one or more digital media content incentives (i.e., content specific) and a content provider incentive (i.e., general to a content provider).

Other example embodiments may include alternate incentive arrangements. For example, a content provider 110 may pay money to a service provider 120 directly to enable the service provider to afford to provide a device provider with a commensurate incentive. In a further variant of such an embodiment, a content provider 110 may give the service provider 120 funds in excess of the incentive to be provided to the device provider 140. In one exemplary embodiment, the service provider 120 will pay an enhanced royalty rate to the content provider 110 to compensate the content provider 110 for the excess funds.

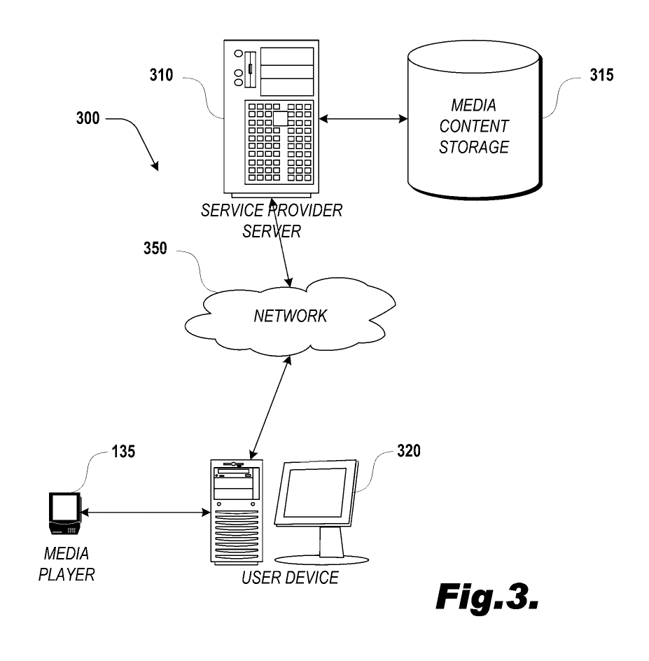

FIG. 3 illustrates an exemplary digital media content provision system 300 having a number of devices used in exemplary embodiments. FIG. 3 illustrates a user computer 320 connected to a service provider server 310 via a network 350 (such as the Internet). Additionally, digital media storage 315 is connected to the service provider server 310 to provide digital media content. Also in communication with the user computer 320 is a digital media content device 135, which is capable of playing the digital media content provided by the service provider server 310.

In alternate embodiments, there may be a plurality of service provider server 310, digital media content storages 315, user computers 320 and digital media content devices 135 coupled to the network 350. Additionally, the service provider server 310 and the digital media content storage 315 may in some embodiments be combined into a single device, or distributed into additional devices. In further embodiments, still additional devices (not shown) may be utilized in the digital media content provision system 300. Likewise, in some embodiments, other devices (both shown and not shown) may be combined.

In some embodiments, a DRM distribution architecture may be used. A DRM distribution architecture produces and distributes digital goods in a fashion that renders the digital goods resistant to many known forms of attacks. The DRM distribution architecture protects digital goods by automatically manipulating portions of the code using one or more protection techniques. Essentially any type of digital good may be protected using this architecture, including such digital goods as multimedia, audio, video, software and other content. For discussion purposes, the example implementations are described in the context of multimedia goods, although the techniques described herein are effective for non-multimedia digital goods.

Accordingly, in some embodiments various DRM techniques may be employed to ensure that digital media content playable on the digital media device 135 is playable only in accordance with the digital rights granted by the DRM information provided by a service provider 120. For example, the transfer of digital media content to the digital media device 135 and a user computer 320 may be limited by the DRM in order to ensure that an incentive is not unfairly take advantage of.

In once such DRM scenario, a digital media device 135 may be locked if the DRM rules are not complied with (or a circumvention attempt is detected), for example if a user stops paying a subscription agreement. Of course, once the electronic media device 135 receives information that DRM rules are in compliance (e.g., a predetermined amount of paid content, a paid subscription, a liquidation fee or the like), it may then be unlocked.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

What is claimed is:

1. A method of providing an incentive for purchasing an electronic device, the method comprising:
obtaining a digital media incentive from a content provider;
enabling the sale of the electronic device at a reduced price related to said digital media incentive;
obtaining revenue for digital media content playable by the electronic device; and
allocating a portion of said revenue to said content provider in relation to said digital media incentive.

2. The method of claim 1 wherein obtaining said digital media incentive comprises obtaining permission to reduce a royalty payment.

3. The method of claim 2 wherein said royalty payment is owed to said content provider.

4. The method of claim 3 further comprising increasing said reduced royalty payment after a period of allocating a portion of said revenue.

5. The method of claim 4 wherein said period corresponds with a period to compensate said content provider for said digital media content incentive.

6. The method of claim 5 wherein said period expires after said revenue reaches a predetermined amount.

7. The method of claim 5 wherein said period expires after a number of digital media content purchases.

8. The method of claim 5 wherein said period expires after a number of digital media content usages.

9. The method of claim 1 wherein enabling the sale of the electronic device comprises providing said digital media incentive to a device seller.

10. The method of claim 1 wherein enabling the sale of the electronic device at a reduced price comprises providing said digital media incentive to a device maker.

11. The method of claim 1 wherein enabling the sale of the electronic device at a reduced price comprises providing said digital media incentive to a device component provider.

12. The method of claim 1 wherein enabling the sale of the electronic device at a reduced price comprises obtaining said digital media incentive from a content provider and providing a digital media incentive to a device seller.

13. The method of claim 1 wherein enabling the sale of the electronic device at a reduced price comprises obtaining said digital media incentive from a content provider and providing a digital media incentive to a device maker.

14. The method of claim 1 wherein enabling the sale of the electronic device at a reduced price comprises obtaining said digital media incentive from a content provider and providing a digital media incentive to a device component provider.

15. The method of claim 1 wherein said digital media incentive comprises at least one of a digital media content incentive and a content provider incentive.

16. The method of claim 15 wherein an allocated portion of said revenue is in relation to at least one of said digital media content incentive and said content provider incentive.

17. The method of claim 1 wherein said digital media incentive corresponds to at least one of a coupon, discount, rebate, mail-in rebate, service plan, subsidy, reduced royalty payment, payment plan, loan and a merchandise credit.

18. The method of claim 1 further comprising receiving an additional incentive from an additional content provider.

19. The method of claim 18 wherein a portion of said revenue is allocated to said additional content provider.

20. The method of claim 19 wherein said revenue is allocated to said additional content provider according to a content count.

21. The method of claim 19 wherein said revenue is allocated to said additional content provider according to a market share of said additional content provider.

22. The method of claim 19 wherein said revenue is allocated to said additional content provider according to a size of said additional incentive.

23. The method of claim 1 wherein obtaining said revenue comprises a payment of a subscription to access an item of digital media content.

24. The method of claim 1 wherein obtaining said revenue comprises a payment for an item of digital media content.

25. The method of claim 1 wherein obtaining said revenue comprises a payment for use of an item of digital media content.

26. The method of claim 1 wherein said digital media content comprises digital rights management data.

27. The method of claim 26 further comprising limiting the transfer of said digital media content to said electronic device from a user computer according to said digital rights management data.

28. The method of claim 26 further comprising locking said electronic device according to said digital rights management data.

29. The method of claim 26 further comprising unlocking said electronic device according to said digital rights management data.

30. The method of claim 29 wherein said digital rights management data indicates at least one of a predetermined amount of paid content, a paid subscription and a liquidation fee.

31. The method of claim 1 further comprising obtaining digital media content from a remote server via a user computer.

32. The method of claim 31 wherein said digital media content is obtained at said user computer pursuant to a digital media content subscription service.

33. A method of providing an incentive for purchasing an electronic device, the method comprising:
determining that a digital media incentive has been provided from a content provider;
enabling the sale of the electronic device at a reduced price related to said digital media incentive;
determining that revenue has been obtained for digital media content playable by the electronic device; and
determining that a portion of said revenue has been allocated to said content provider in relation to said digital media incentive.

34. An incentive for use by a device provider to reduces the cost for purchasing a digital media content playing electronic device, wherein the incentive is obtained by:
determining that an incentive has been provided from a content provider;
enabling the sale of the electronic device at a reduced price related to said incentive;
determining that revenue has been obtained for digital media content playable by the digital media content playing electronic device; and
determining that a portion of said revenue has been allocated to said content provider in relation to said incentive.

35. A method of providing an incentive for purchasing an electronic device, the method comprising:
obtaining a digital media incentive from a content provider by obtaining permission to reduce a royalty payment to said content provider;
enabling the sale of the electronic device with a discount related to said digital media incentive;
obtaining payment for use of digital media content, including digital rights management data, playable by the electronic device;
allocating a portion of said payment for use of digital media content to said content provider in relation to said digital media incentive; and
increasing said royalty payment after a period to compensate said content provider for said digital media content incentive.
